(19) United States
(12) Patent Application Publication
(10) Pub. No.: US 2014/0272014 A1
(43) Pub. Date: Sep. 18, 2014

(54) PROCESS FOR STORAGE OF RAW VEGETABLES

(71) Applicant: Jay Joseph Janicke, Linwood, MI (US)

(72) Inventor: Jay Joseph Janicke, Linwood, MI (US)

(21) Appl. No.: 13/832,268

(22) Filed: Mar. 15, 2013

(51) Int. Cl. A23B 7/00

(52) U.S. Cl. CPC A23B 7/00
USPC 426/106; 426/324

(57) ABSTRACT

The present invention is a process for providing storage of raw fruit and vegetables. The process, essentially at room temperature, comprises whole or a comminuted raw vegetable; a preservative solution; a sealable, flexible plastic container; placing the comminuted raw vegetables and the preservative solution in the container, and sealing the plastic container.

### BACKGROUND OF THE INVENTION

The applicant is aware of the following prior art as it concerns the present application. There are many processes for storage or preservation of raw fruits and vegetables. However, none of the prior art examples have the utility of the present invention.

The use of canning and packaging to preserve cucumbers is not new to the art. Typically canning includes steps of exposing the cucumbers to some degree of heat and then storing them in a brine solution or suspension for an extended period of time, this could include months, and then packaging. It also may include a step of rinsing to reduce the level of salt in the finished product. All of these steps require large amounts of time and energy.

U.S. Pat. No. 5,922,383 issued to Cook on Jul. 13, 1999, entitled, “Method For Brine Free Long Term Storage of Pickles”, discloses a method for preservation of cucumbers in a prepackage process that includes a brine treatment that is heated to a temperature of 195° F. and then refrigerated for 24 to 72 hours to achieve preservation. This process is costly and time consuming.

U.S. Pat. No. 3,865,351 issued to Connick on Feb. 11, 1975 describes a process for continuously exposing salt to water in order to produce a saturated brine that may be stored. Separately, a supply of liquid dextrose or liquid sugar is maintained in a heated condition. Measured quantities of the liquid dextrose are periodically introduced into a mixing zone of a mixer with water. The dextrose and water are agitated and additional ingredients such as phosphates and curing salts are passed to the mixer and then mixed to produce the brine, all in an effort to reduce curing time.

### THE INVENTION

The present invention is a process for providing storage of raw fruits and vegetables. The process, essentially at room temperature, comprises a comminuted raw fruits and vegetables; a preservative solution; a sealable, flexible plastic container; placing the comminuted raw fruit or vegetables and the preservative solution in the container, and sealing the flexible plastic container.

Comminuted or comminution is the act or action of comminuting or the fact of being comminuted; trituration, pulverization into a number of pieces. Thus, for purposes of this invention, “comminuted” means reduction in size by grinding, dicing, crushing, or slicing.

The present method requires only that the cucumbers be prepared by cleaning, obtaining the correct vegetable size (sliced, diced, ground or whole), then packaging. The prepackage brining and cooking have been eliminated. This reduces time and cost making the present invention much more utilitarian. The present invention has eliminated the steps of pre-curing and heating or cooking.

### DETAILED DESCRIPTION

The process for making cucumbers suitable for human consumption are prepared for packaging either whole or at the desired cut and style suitable for a pickled cucumber.

The product is to be kept and stored in refrigerated conditions. Preservative are used as needed to maintain freshness. The finished product pH (or titratable acidity) is to be maintained at less than 4.60 per FDA 21 CFR 114 Acidified Foods.

The cut or whole cucumbers are placed in a flexible leak proof pouch or bag and cover brine is added to the pouch. The pouch is then sealed with minimal air remaining in the bag.

The pickle cover brine make-up is a mixture of ingredients including but not limited to water, salt, vinegar, acids, sweeteners, spices, oils, preservatives and color, combined into a solution. The chemical analysis (salt, acid and pH) parameters are based on the perspective ratio of the final pack.

Typical ranges for chemical analysis for these characteristics are, but not limited to;

Titratable Acid (grains)—Level is set to a range that will be dependent on the finished product specification for the required pH specification which is directly affected by the level of acid in the finished product.

Salt (%)—Dependent on the finished product specification can be varied.

The dependent factor of “cover brine” is the final equilibrium pH of the finished product which must remain below 4.60 with a target pH that will maintain the maximum as the upper limit control for pH.

The process for packaging the fresh produce suitable for human consumption prepared for packaging either whole or by cutting or slicing at the desired cut and style that is suitable as a product.

“Flexible plastic container” for purposes of this invention means any plastic that is flexible enough to be handled by equipment and or by manual handling and can include such materials as Curwood CURLON 9501 and 9506 flexible thermoforming film, Cryovac OS systems active barrier films, Cryovac FS 7000 series film and Cryovac FS 8155 ultra-high-barrier film and the like. However, for purposes of this invention, the flexible plastic does not have to be O₂ impermeable, as small amounts of oxygen (air) do not impact the preservation of the materials therein.

The products provided by this process have an average shelf life for up to 12 months.

What is claimed is:

1. A process for providing storage of raw fruits and vegetables, said process, essentially at room temperature, comprising
a. providing a comminuted raw fruit and vegetable;
b. providing a preservative solution;
c. providing a sealable, flexible plastic container;
d. placing said comminuted raw fruit and vegetables and said preservative solution in said flexible plastic container, and, sealing said plastic container with a minimum of air.

2. In combination, comminuted raw fruit and vegetables, preservative solution contained in a sealable, flexible plastic container, wherein the container is sealed after placing the comminuted raw fruits and vegetables and preservative solution therein.

3. Comminuted raw fruits and vegetables preserved by the process as claimed in claim 1.

4. The process as claimed in claim 1 wherein the sealable, flexible plastic container is not oxygen impermeable.

5. The process as claimed in claim 1 wherein the sealable, flexible plastic container is oxygen impermeable.

6. The process as claimed in claim 1 wherein a portion of air contained in the sealable, flexible plastic container is displaced prior to sealing.

7. The comminuted raw fruits and vegetables as claimed in claim 3 wherein the comminuted raw fruits and vegetables are cucumber.

8. The comminuted raw fruits and vegetables as claimed in claim 7 wherein the cucumber is sliced.

9. The comminuted raw fruits and vegetables as claimed in claim 7 wherein the cucumber is whole.

10. The process as claimed in claim 1 wherein the product of D is refrigerated.

11. A process for providing storage of raw fruits and vegetables, said process, essentially at room temperature, comprising
a. providing a whole raw fruit and vegetable;
b. providing a preservative solution;
c. providing a sealable, flexible plastic container;
d. placing said whole raw fruit and vegetables and said preservative solution in said flexible plastic container, and, sealing said plastic container with a minimum of air.

12. The process as claimed in claim 11 wherein the product of D is refrigerated.
